(19) United States
(12) Patent Application Publication
(10) Pub. No.: US 2008/0200116 A1
(43) Pub. Date: Aug. 21, 2008

(54) Multi Beam Repeater Antenna for Increased Coverage

(76) Inventors: Silvia Raffaelli, Cambridge (GB); Mats Andersson, Goteborg (SE); Martin Nils Johnsson, Molndal (SE)

Correspondence Address: ERICSSON INC., 6300 LEGACY DRIVE, M/S EVR 1-C-11, PLANO, TX, 75024, US

(21) Appl. No.: 11/994,464

(22) PCT Filed: Jul. 4, 2005
(86) PCT No.: PCT/SE2005/001078

§ 371 Date: Mar. 4, 2008

(51) Int. Cl. H04B 7/155; H01Q 1/38; H01Q 21/06

(52) U.S. Cl. 455/7; 343/893; 343/700 MS

(57) ABSTRACT

The invention discloses a repeater antenna for use in telecommunications systems on the microwave range, intended to connect a first radio unit at a first site to a second radio unit at a second site (A). The repeater antenna has at least a first and a second antenna element and a feed network for said antenna elements, the antenna elements giving rise to a first and a second antenna beam. The first beam can be used to connect the repeater antenna to said first radio unit, and the second beam can be used for connecting the repeater antenna to said second radio unit. Also, said first and second antenna elements are arranged on a surface where the distance between the two antenna elements along the surface is longer than the shortest distance between the antenna elements.

### TECHNICAL FIELD

The present invention discloses a repeater antenna for use in telecommunications systems in the microwave range. The repeater antenna is intended for connecting transmissions from a first radio unit at a first site to a second radio unit at a second site.

### BACKGROUND ART

In telecommunications systems such as, for example, cellular telephony systems in the microwave range, there can be a number of problems for a base station when trying to communicate with the users located in the area covered by the base station, said area being referred to as “a cell”, said problems being particularly noticeable in systems that use a high bit rate In urban areas, examples of such problems can be high-rise buildings which obstruct the line of sight to certain sub-areas, or that in certain sub-areas the number of users can exceed that which can be handled by the base station.

One way of handling these problems, especially in the case of areas where the line-of-sight is obscured, is to use so called repeater antennas, i.e. antennas which are installed at a location where they may be reached from the base station, and from which location they may also relay transmissions to and from the obscured area.

Another way of handling the described problems, especially in the case of sub-areas within the cell with an amount of users which is too large to be handled by the base station, is to install other base stations which can cover the sub-areas in question, usually base stations with smaller capacity, so called “pico-stations”.

These “pico-stations” then need to be connected to the network in some way, suitably with the pico-station as one of the points in a point-to-point connection. Said point-to-point connection could be made by means of a repeater station, which would be directed at the “pico-station” from the base station, or from another higher level node in the network.

Conventional repeater antennas are usually designed by means of two reflector antennas, often parabolic dishes, connected by means of a wave-guide and pointed in different directions. Installing such repeaters, especially in urban areas, is becoming increasingly difficult, due to a number of factors such as aesthetic considerations and difficulties in finding sufficient space for a repeater site.

Another kind of previously known repeater is merely a large sheet of reflective material, such as metal. Such a repeater would suffer from a number of drawbacks, for example high losses due to low directivity, and would generally not be suitable for use in urban areas.

### DISCLOSURE OF THE INVENTION

As described above, there is thus a need for a repeater antenna in a telecommunications system on the microwave range which would overcome the previously described drawbacks of known repeater antennas.

This need is addressed by the invention in that it discloses a repeater antenna for use in telecommunications systems on the microwave range, the repeater antenna being intended to connect a first radio unit at a first site to a second radio unit at a second site.

The disclosed repeater antenna has at least a first and a second antenna element and a feed network for these antenna elements, and the antenna elements give rise to first and second antenna beams, so that the first beam can be used for connecting the repeater antenna to said first radio unit, and the second beam can be used for connecting the repeater antenna to said second radio unit.

In the repeater antenna, said first and second antenna elements are arranged on a surface where the distance between the two antenna elements along the surface is longer than the shortest distance between the antenna elements, in other words a non-flat surface, either a curved or bent such surface.

In one embodiment of the repeater antenna, at least one of said first and second antenna elements are part of an array comprising a plurality of antenna elements. In one version of this embodiment, the repeater antenna can suitably have a longitudinal and a lateral direction of extension, and the array of antenna elements is a one-dimensional array which is arranged to coincide with one of said directions of extension of the antenna. In another version of this embodiment, the array of antenna elements is a two-dimensional array, with the two dimensions being arranged to essentially coincide with one of said directions of extension of the antenna.

Suitably but not necessarily, the antenna elements can be essentially plane and created on a sheet of electrically conducting material, and the repeater antenna additionally comprises a ground plane spaced apart from the antenna elements by means of a dielectric material.

Thus, by means of the invention, a repeater antenna is disclosed which can direct beams in more or less any azimuth (horizontal) or elevational angle so that it can have one beam which covers the base station antenna, and a second beam which covers an area within the cell where there is a need for additional coverage in addition to that afforded by the base station antenna. Said first and second beams can be separated by a more or less arbitrary angle, so that the repeater antenna can be used in a highly versatile manner.

### BRIEF DESCRIPTION OF THE DRAWINGS

The invention will be described in more detail in the following description, with reference to the appended drawings, in which

FIG. 1 shows a basic view of a system in which the repeater antenna of the invention can be applied, and

FIG. 2 shows a basic view of the system of FIG. 1 in which the repeater antenna of the invention is used, and

FIG. 3 shows a top view of the system of FIG. 2, and

FIG. 4 shows a schematic top view of repeater antenna of the invention, and

FIGS. 5-7 show more detailed embodiments of the repeater antenna.

### EMBODIMENTS OF THE INVENTION

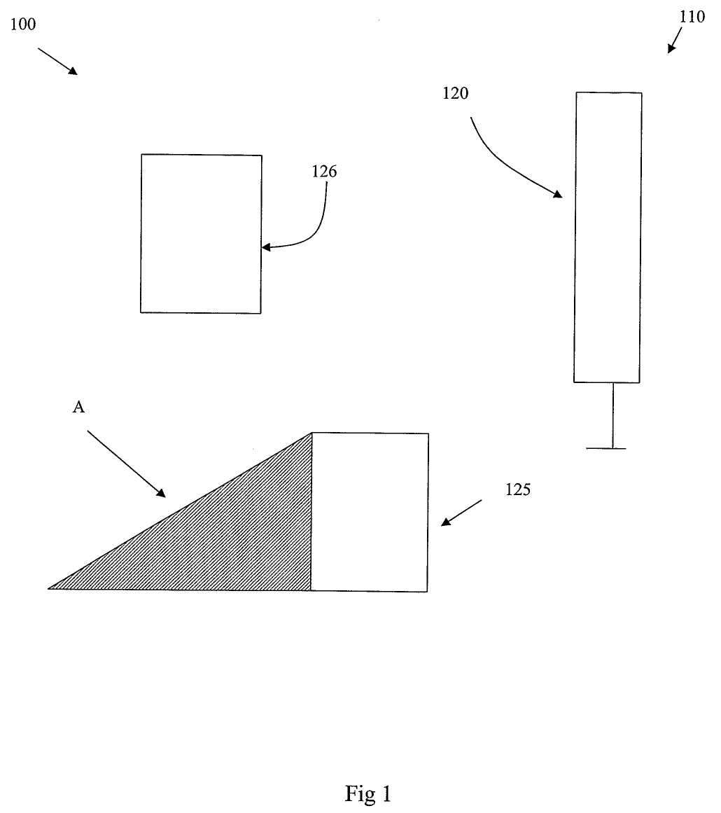

FIG. 1 shows an example of a telecommunications system 100 in which the invention may be used. The system 100 shown in this example is a cellular telephony system in the microwave range, i.e. from 1 GHz and upwards.

In the system 100, there is a base station 110 which is connected to higher levels in the system. The radio base station uses one or several antennas 120 in order to cover a certain area, a so called cell, within which the base station handles communication to and from users of the cellular systems, as well as all control of the telephones of said users.

The cell of the system 100 is located in an urban area with one or several high-rise buildings 125, 126, which block the communications from the base station antenna 120 to one or more areas. Thus, there will be areas such as the shaded area A within the cell which can only be serviced at degraded bit rates or which cannot be serviced at all by the base station 110 by means of the coverage given by the base station antenna 120.

There can also be a number of other factors which would make it difficult or impossible for the base station 110 to service users in an area within the cell, one such reasons being that the number of users in that particular area is so high that the total number of users in the entire cell exceeds the base station's capacity.

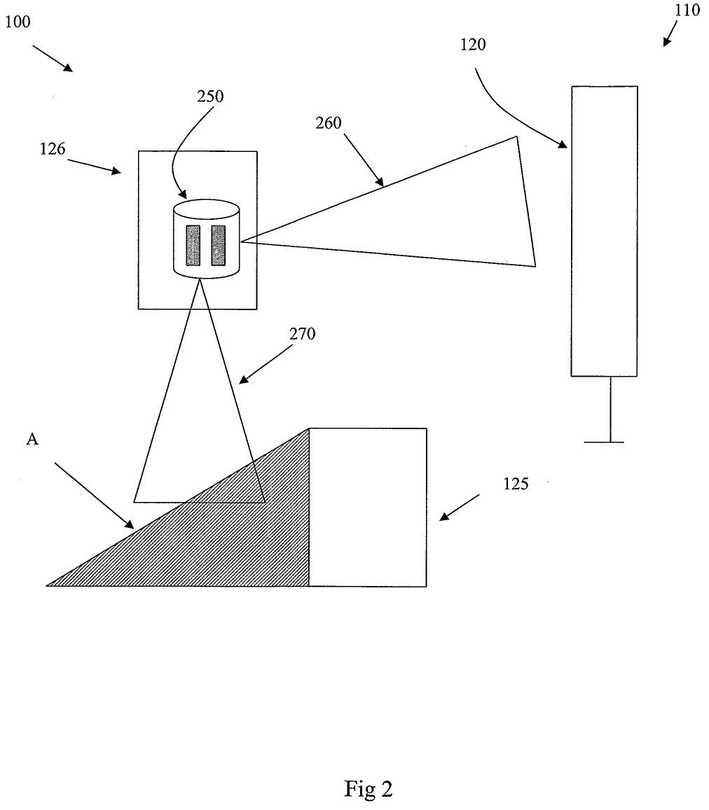

FIG. 2 shows the system of FIG. 1 with some additional equipment, which will be described in the following. In order to service users of the system in the area A, a repeater antenna 250 of the invention has been deployed, in this case on top of the building 126. The repeater antenna 250 is intended to connect the base station to one or more users of the system at sites within the area A.

As shown in FIG. 2, the repeater antenna has at least a first 260 and a second 270 antenna beam. As will be shown in more detail later on, the first beam can be used for reception of the signals from the base station, and the second beam can be used for transmitting the received signals to area A, to one or more users within that area.

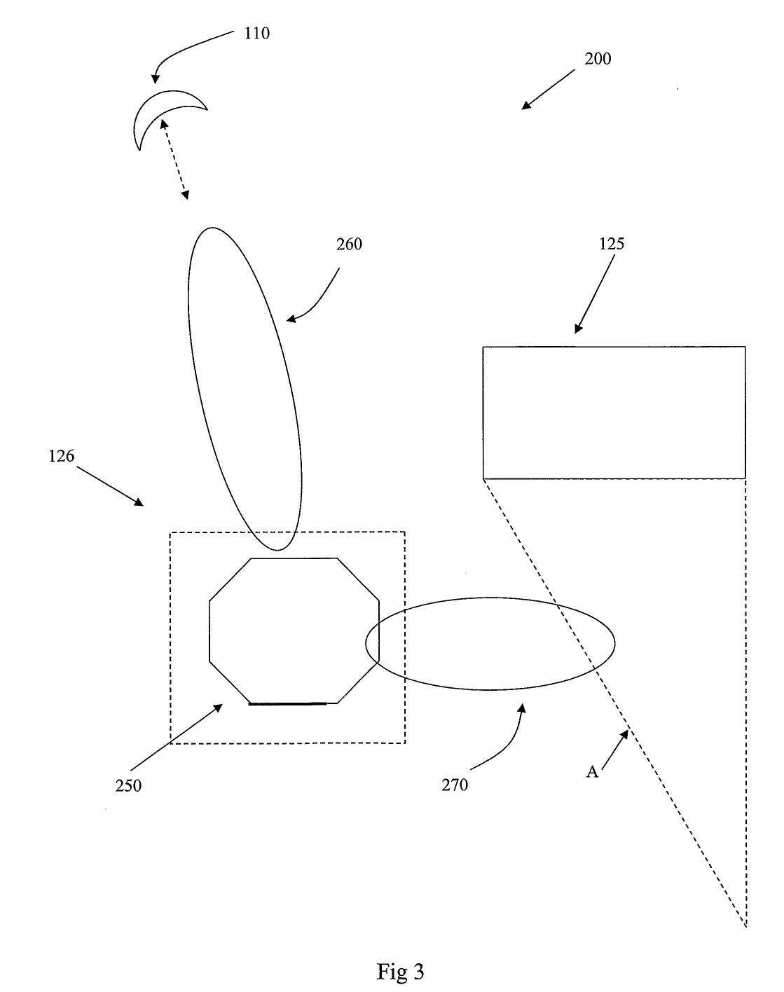

In FIG. 3, the system 200 of FIG. 2 is shown in a schematic “top view”. As seen here, the repeater antenna 250 is deployed on top of one of the buildings 126, from where there is line of sight to the obscured area A. The repeater antenna has the two beams 260, 270 mentioned previously, the first 260 of which is directed so that it covers the base station, and the second 270 of which is so directed that it covers the obscured area A. Thus, the repeater antenna 250 can connect the base station 110 to users in area A, users which would otherwise have been unable to connect to the base station, particularly if they wish to connect at high bit rates, such as typically 0.5 Mbps or higher.

In another application of the repeater antenna, if the users in area A aren't obscured from line of sight from the base station, or if they in addition to being obscured are also of such a quantity that the base station can't handle them, the system may be expanded to comprise an additional base station dedicated to servicing area A. This additional base station can be one which is similar to the base station 110, or it can be a so called “pico” base-station, i.e. a base station which has a smaller capacity than the base station 110, the pico station being a type of base station which is specifically intended to aid larger base stations. The repeater antenna would then be installed so that it connects the pico station to the base station, the pico station handling the users in area A, instead of those users being handled directly by the base station.

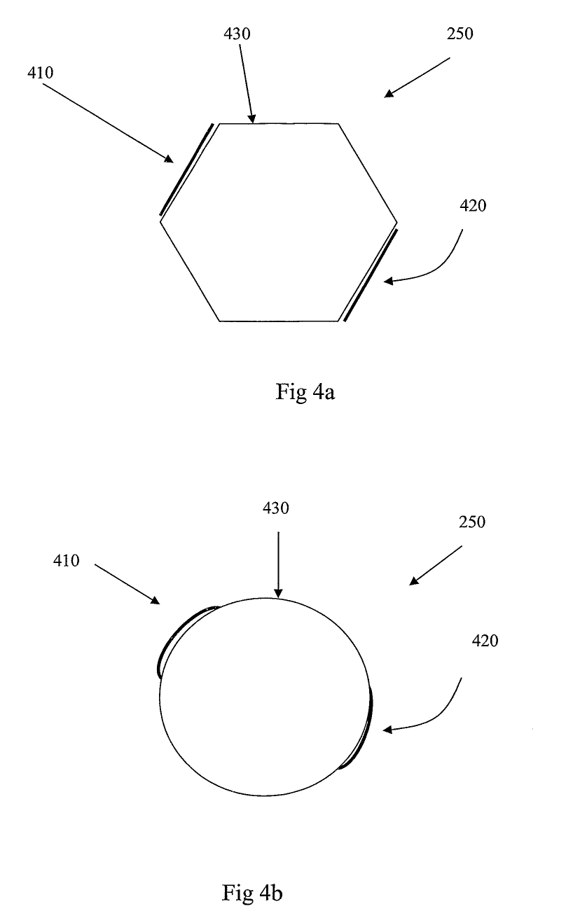

The first and the second antenna beams of the repeater antenna are, in order to meet the demands of the system, separated by a more or less arbitrarily chosen angle α. In order to achieve this, as shown in FIGS. 4a and 4b, where two embodiments of the repeater antenna 250 are shown in a top view, the repeater antenna comprises a first 410 and a second 420 antenna element, which are arranged on a surface 430 where the distance between the two antenna elements along the surface is longer than the shortest distance between the antenna elements. In other words, the surface on which the antenna elements are arranged is curved or bent. The antenna elements as such can either follow the shape of the surface, i.e. curved or bent, or they can be essentially straight, as shown in FIGS. 4a and 4b respectively.

Before the design of the repeater antenna is described in more detail, one more aspect of the repeater antenna should be mentioned: the repeater antenna can be either an active or a passive antenna. In other words, the repeater antenna can either passively relay signals which have been received in one beam to be transmitted by another of the antenna beams, or the received signals can be amplified before they are re-transmitted. One and the same repeater antenna could in fact be used for both applications: if the repeater is to be used in a passive mode, the input/output ports to the respective beams would simply be connected to each other, and if the repeater is to be used in an active mode, the same ports could be connected to each other via an external amplifying equipment.

Naturally, the repeater antenna could also be designed as an active or passive repeater from the beginning.

Turning now to some examples of the more exact design of the repeater antenna, the antenna is suitably but not necessarily designed as a so called “patch antenna”. Such an antenna comprises as radiation elements patches of an electrically conducting material, which have usually been created on a non-conducting layer or substrate, in a manner which as such is well known within the art. The “patch” type of antenna will also comprise a ground plane, i.e. another plane of electrically conducting material, which is spaced apart from the radiation elements by means of a dielectric material, usually in the form of a separate physical layer of, but said layer of dielectric material may also be no more than a layer of air.

The patch antenna also comprises a feeder network, by means of which the radiation elements are connected to input/output ports of the antenna, and also possibly to each other, and, where applicable, to other components of the antenna, such as, for example, phase shifters.

The feed network can be created in the same conducting layer as the radiation elements, or as a separate network which would then, for example, be connected to the radiation elements by means of through-holes in the ground plane.

The design of the feed network for the radiation elements can be chosen from a large number of principles, such as, for example, connecting radiation elements so that they form so called travelling wave antennas, or the feed network can be a Butler matrix antennas or there can even be individual antenna patches with individual feeder networks.

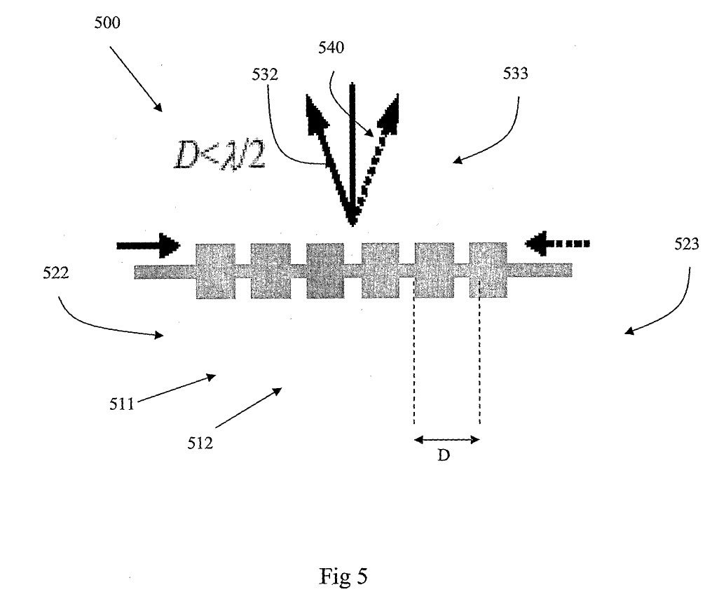

An example of a travelling wave antenna 500 is shown in FIG. 5: the antenna 500 comprises at least a first 511 and a second 512 radiation element, which are arranged in series at a centre distance D from each other.

Since the radiation elements are connected serially to each other there will be a first and a second “end element” to which are attached input/output ports 522, 523, of the antenna 500.

As shown in FIG. 5, the antenna 500 has a first and a second antenna beam 532, 533, each of which is associated with one of the antenna ports 522, 523. This means that the first beam 532 may be used by accessing the first port 522, and in a similar way the second beam 533 is associated with the second port 523. The angle between the beams is determined by the centre distance D between the antenna elements of the antenna.

As can also be seen in FIG. 5, the two antenna beams of the travelling wave antenna are each other's “mirror image” with respect to an imagined line 540 which extends in a direction perpendicular to the antenna. Thus, the two beams are sometimes referred to as the “plus” or the “minus”-directions.

The Butler matrix antenna will only be commented upon briefly here, since it is also quite well known within the art. A Butler matrix antenna comprises N input/output ports, and produces N antenna beams. By means of a network internal to the Butler matrix, a signal input at any one of the input/output ports produces equal amplitudes at all of the antenna ports, and a linear phase progression from (antenna) port to port. If the antenna ports are connected in sequence to an equally spaced linear antenna array, one antenna beam is formed for each input/output port.

The internal network may comprise phase shifters and hybrids, and by externally combining two or more of the input/output ports, the antenna diagram can be moved, broadened or be given altered side lobe levels.

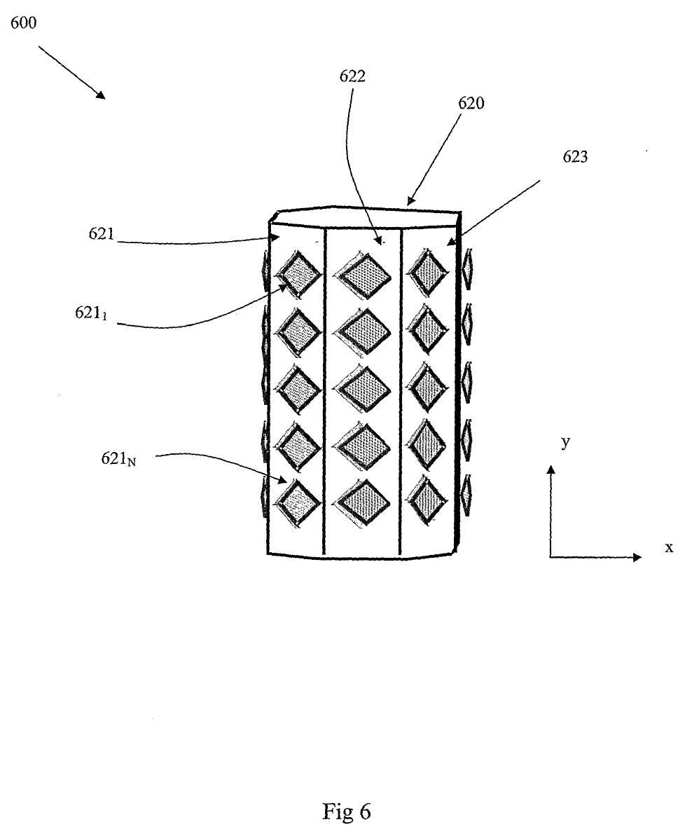

FIG. 6 shows a preferred embodiment 600 of the repeater antenna. As can be seen here, the antenna comprises a bent surface 620, in this case an octagonal surface or body. Said body is elongated, i.e. it has a longitudinal (y) and a lateral (x) direction of extension, with the longitudinal extension in this case exceeding the lateral one, and there is arranged a number of arrays 621-623 of antenna elements 621₁-621_{N} on each of the flat surfaces of the octagonal body, so as to afford a 360-degree coverage. Naturally, the body of the antenna can be hexagonal or any other shape with a plurality of surfaces in different directions, or it can be cylindrical, as shown in FIG. 4.

As shown in FIG. 6, the antenna arrays 621-623 are one-dimensional arrays, i.e. column arrays, which are arranged to coincide with one of said directions of extension of the repeater antenna, in this case the lateral extension (y). Thus, the previously mentioned first and second antenna elements are in this embodiment part of respective arrays comprising a plurality of antenna elements.

This array can be one-dimensional, as shown in FIG. 6, or it can be a two-dimensional array, said two dimensions being arranged to essentially coincide with the two main directions of extension of the repeater antenna.

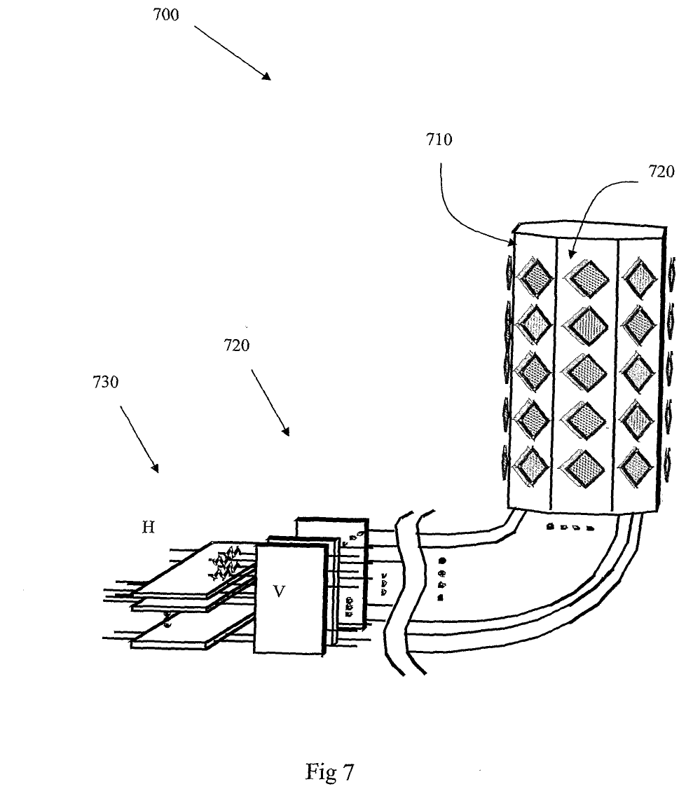

FIG. 7 shows another embodiment 700 of a repeater antenna according to the invention:

The antenna 700, in similarity to the antennas shown previously, has a first 710 and a second 720 plurality of radiation elements, here shown as column arrays on the sides of an octagon. Both of said pluralities are connected to a two-dimensional beam forming network, by means of which a plurality of beams or radiation diagrams can be generated in both the azimuth (horizontal, “H”) and elevation (Vertical, “V”) directions. By means of the antenna 700, separate beams may thus be formed for a number of relevant areas within a cell, in order to, for example, cover the base station and the obscured areas “A” described above.

As indicated in FIG. 7, in the antenna 700 is a cylindrical array antenna, in this case an octagon, which, as mentioned, is equipped with beam-forming networks in two dimensions, both elevation and azimuth, so that a plurality of beams may be formed in elevation.

As an example, the antenna 700 may feed each individual column with a separate feeder network, and the signals from the output ports of the vertical feed networks 720 can be combined using two or more beam-forming networks 730 in azimuth.

Beam forming could here be carried out in both the vertical and horizontal (azimuth) direction. Calibration could also be implemented on column-basis only, i.e. between columns, with fixed beam forming networks within the columns.

Beam-forming networks (for example Butler matrices) can be applied to one or both of two orthogonal polarizations (in the case of dual-polarized antenna elements) and can connect to different numbers of antenna elements in elevation.

The invention is not limited to the examples of embodiments shown above, but may be freely varied within the scope of the appended claims. For example, different polarizations maybe used in the different antenna beams, or one or more of the antenna elements may be dual polarized.

The radiation elements or antenna elements are typically so called patch antennas, but can also be dipoles or any other type of radiation elements, as is well known to those skilled in the field.

It can also be pointed out that the repeater antenna can utilise any number of the beams it generates in order to achieve the desired coverage. For example, a repeater antenna with four beams could use one beam to receive in and two beams pointed in different directions to retransmit the data it has received.

1.-7. (canceled)

8. A repeater antenna for use in a telecommunications system in the microwave range, adapted to connect a first radio unit at a first site to a second radio unit at a second site, said repeater antenna comprising:
at least a first and a second antenna element; and
a feed network for said antenna elements, the antenna elements giving rise to a first and a second antenna beam, such that the first beam can be used to connect the repeater antenna to said first radio unit, and the second beam can be used to connect the repeater antenna to said second radio unit;
the repeater antenna further comprising said at least first and second antenna elements being arranged on a surface where the distance between the two antenna elements along the surface is longer than the shortest distance between the antenna elements.

9. The repeater antenna of claim 8, in which the design of the feed network for the antenna elements is chosen from at least one of the following: travelling wave antennas, butler matrix antennas or individually fed antenna patches.

10. The repeater antenna of claim 9, in which the antenna elements in addition to being plane also are flat.

11. The repeater antenna of claim 8, wherein the antenna elements are essentially plane and created on a sheet of electrically conducting material, and wherein the repeater antenna additionally comprises a ground plane spaced apart from the antenna elements by means of a dielectric material.

12. The repeater antenna of claim 11, in which the antenna elements in addition to being plane also are flat.

13. The repeater antenna of claim 8, wherein at least one of said first and second antenna elements are part of an array comprising a plurality of antenna elements.

14. The repeater antenna of claim 13, further having a longitudinal (x) and a lateral (y) direction of extension, and in which said array of antenna elements is a one-dimensional array which is arranged to coincide with one of said directions of extension of the repeater antenna.

15. The repeater antenna of claim 14, wherein the antenna elements are essentially plane and created on a sheet of electrically conducting material, and wherein the repeater antenna additionally comprises a ground plane spaced apart from the antenna elements by means of a dielectric material.

16. The repeater antenna of claim 15, in which the antenna elements in addition to being plane also are flat.

17. The repeater antenna of claim 14, in which the design of the feed network for the antenna elements is chosen from at least one of the following: travelling wave antennas, butler matrix antennas or individually fed antenna patches.

18. The repeater antenna of claim 17, in which the antenna elements in addition to being plane also are flat.

19. The repeater antenna of claim 13, further having a longitudinal (x) and a lateral (y) direction of extension, and in which said array of antenna elements is a two-dimensional array, said two dimensions being arranged to essentially coincide with one of said directions of extension of the repeater antenna.

20. The repeater antenna of claim 19, wherein the antenna elements are essentially plane and created on a sheet of electrically conducting material, and wherein the repeater antenna additionally comprises a ground plane spaced apart from the antenna elements by means of a dielectric material.

21. The repeater antenna of claim 20, in which the antenna elements in addition to being plane also are flat.

22. The repeater antenna of claim 19, in which the design of the feed network for the antenna elements is chosen from at least one of the following: travelling wave antennas, butler matrix antennas or individually fed antenna patches.

23. The repeater antenna of claim 22, in which the antenna elements in addition to being plane also are flat.
